(19) United States
(12) Patent Application Publication
(10) Pub. No.: US 2006/0047059 A1
(43) Pub. Date: Mar. 2, 2006

(54) Coloring binder for pavement of a road and method for producing the same

(76) Inventors: SengWoo Yoon, Anyang-si (KR); Choon Bae Lee, Ulsan-si (KR); Sang-Il Hong, Seoul (KR)

Correspondence Address: BARLOW, JOSEPHS & HOLMES, LTD., 101 DYER STREET, 5TH FLOOR, PROVIDENCE, RI, 02903, US

(21) Appl. No.: 11/203,896

(22) Filed: Aug. 15, 2005

(30) Foreign Application Priority Data
Aug. 31, 2004 (KR) 10-2004-0069200

(51) Int. Cl. C09B 67/00

(52) U.S. Cl. 524/502

(57) ABSTRACT

Disclosed herein is a coloring binder, and method of preparing it, which is mixed with a colored asphalt concrete mixture for use in road pavement, thus ensuring clear color and excellent weather resistance and durability. The method includes loading rubber latex into a mixer; loading process oil heated to 140-180° C. into the mixer having the rubber latex loaded therein, and then stirring the loaded process oil; loading a plasticizer and a thermoplastic resin into the mixer having the process oil loaded and stirred therein, and then stirring the loaded plasticizer and thermoplastic resin; loading a thermoplastic elastomer into the mixer having the plasticizer and thermoplastic resin loaded and stirred therein, and then stirring the loaded thermoplastic elastomer; and loading a dispersion pigment into the mixer having the thermoplastic elastomer loaded and stirred therein, and then stirring the loaded dispersion pigment, in which the dispersion pigment is processed by uniformly dispersing a powdered pigment in the process oil, the thermoplastic resin, or the plasticizer serving as a dispersion medium, and the rubber latex is added in an amount of 2-6 wt %, the process oil is added in an amount of 22-50 wt %, the thermoplastic resin is added in an amount of 32-60 wt %, the thermoplastic elastomer is added in an amount of 5-15 wt %, the plasticizer is added in an amount of 1-4 wt %, and the dispersion pigment is added in amount of 10-20 wt %, based on 100 wt % of the coloring binder.

### BACKGROUND OF THE INVENTION

The present invention relates generally to a method of preparing a coloring binder for road pavement and a coloring binder prepared thereby. More particularly, the present invention relates to a coloring binder, which is mixed with a colored asphalt concrete mixture for use in paving a road, thus assuring a clear color and excellent weather resistance and durability.

Presently, bicycle paths, park roads, playgrounds, etc., in Korea, are paved with colored concrete or colored asphalt. However, the colored concrete and colored asphalt have the following problems.

In the colored concrete, concrete is cured for a considerably long time to realize compression strength required for vehicle roads. Further, epoxy coating requires a long epoxy curing time. Upon construction, the colored concrete is disadvantageous because a complicated process involving an expansion joint must be conducted, and a construction period is lengthened, thus increasing personnel expense. After construction, due to weak impact resistance, cracks may easily be generated. Also, efflorescence of the concrete results in unclear color and rapid discoloration. As well, maintenance of the colored concrete is difficult. In this way, the colored concrete is not easy to apply to road.

In the colored asphalt, which is obtained by adding a powdered pigment to a colorless transparent binder, the pigment is impossible to sufficiently disperse, and thus, the pigment and the binder are heterogeneously mixed. Thereby, when the constructed asphalt is used, the pigment may be extracted from the binder and diffused. Further, a system for adding pigment to a dry mixing process causes the binder to be weakly attached to the aggregate, and thus, the resulting mixture has undesirable properties. Moreover, the film may peel upon use, and the aggregate may be separated. Moreover, during rainy days, holes may form and the pigment may flow out.

On vehicle roads at high temperatures in the summer season, fluidity may occur due to softening of the asphalt and binder, and wheel marks and pollutants are attached to the sticky surface of the paved road, whereby the color of the asphalt disappears. In addition, resistance to plastic deformation is low, and therefore, the colored asphalt is unsuitable for road pavement.

To overcome the above problems, Korean Patent Laid-open Publication No. 2003-59753 discloses a colored road paving method, which includes paving and compacting porous asphalt concrete, and spraying a coloring polymer mixture onto the paved and compacted porous asphalt concrete, thereby shortening the curing time and easily exhibiting desired color. However, the above patent has shortcomings such as low weather resistance and durability.

### SUMMARY OF THE INVENTION

Accordingly, the present invention has been made keeping in mind the above problems of conventional colored concrete and colored asphalt occurring in the prior art, and an object of the present invention is to provide a method of preparing a coloring binder for road pavement and a coloring binder prepared thereby. As such, when the binder, modified using various polymers such as rubber latex, a thermoplastic resin, a thermoplastic elastomer, etc., is prepared, a pigment is sufficiently pre-dispersed in the binder to color the binder, whereby various colors may be exhibited depending on the pigment dispersed in the binder, and the properties of a road paving material may be sufficiently improved. In addition, when using the above binder in a general asphalt concrete plant, since such a general asphalt concrete plant may be used unchanged, additional costs for modification of the general asphalt concrete plant are not incurred.

Another object of the present invention is to provide a method of preparing a coloring binder for road pavement and a coloring binder prepared thereby, in which the coloring binder is constructed in the same manner as conventional asphalt concrete, and thus, problems including a long construction period, complicated processes and high personnel expense, associated with the color pavement of a road, may be overcome. In addition, cracks are not generated thanks to the inherent ductility and hardness of the binder, and excellent color stability, easy of construction, and high durability due to high grip strength and adhesion to aggregates may be exhibited.

### DETAILED DESCRIPTION OF THE PREFERRED EMBODIMENT

In order to achieve the above objects, the present invention provides a method of preparing a coloring binder for road pavement, comprising loading rubber latex into a mixer; loading process oil heated to 140-180° C. into the mixer having the rubber latex loaded therein, and then stirring the loaded process oil; loading a plasticizer and a thermoplastic resin into the mixer having the process oil loaded and stirred therein, and then stirring the loaded plasticizer and thermoplastic resin; loading a thermoplastic elastomer into the mixer having the plasticizer and thermoplastic resin loaded and stirred therein, and then stirring the loaded thermoplastic elastomer; and loading a dispersion pigment into the mixer having the thermoplastic elastomer loaded and stirred therein, and then stirring the loaded dispersion pigment, in which the dispersion pigment is processed by uniformly dispersing powdered pigment in the process oil, the thermoplastic resin, or the plasticizer serving as a dispersion medium, and the rubber latex is added in an amount of 2-6 wt %, the process oil is added in an amount of 22-50 wt %, the thermoplastic resin is added in an amount of 32-60 wt %, the thermoplastic elastomer is added in an amount of 5-15 wt %, the plasticizer is added in an amount of 1-4 wt %, and the dispersion pigment is added in amount of 10-20 wt %, based on 100 wt % of the coloring binder.

In addition, the present invention provides a coloring binder, comprising 2-6 wt % rubber latex, 22-50 wt % process oil, 32-60 wt % thermoplastic resin, 5-15 wt % thermoplastic elastomer, 1-4 wt % plasticizer, and 10-20 wt % dispersion pigment, in which the dispersion pigment is processed by uniformly dispersing a powdered pigment in the process oil, the thermoplastic resin, or the plasticizer serving as a dispersion medium.

Hereinafter, a detailed description will be given of the present invention to the extent that those skilled in the art may easily realize the present invention.

First, rubber latex is loaded into a mixer. The rubber latex functions to improve the high-temperature and low-temperature properties of a binder, and in particular, reinforce the low-temperature elasticity, increase the high-temperature viscosity, and enhance the high-temperature fluidity of asphalt concrete. The rubber latex is selected from among solid and latex type styrene butadiene rubber, natural rubber latex (NR), and mixtures thereof, but is not limited thereto.

After the rubber latex is loaded and stirred, process oil heated to 140-180° C. is loaded into the mixer, and then stirred. The process oil is used to confer ductility and fluidity to a binder and improve low-temperature performance, and also importantly functions to promote the uniform mixing of other components. The process oil is selected from among aromatic, paraffin, naphthenee process oils, and mixtures thereof, but is not limited thereto.

If the temperature of the heated process oil is less than 140° C., water is difficult to evaporate from the latex, and thus, dispersion is not realized. Meanwhile, if the above temperature exceeds 180° C., the water in the latex may drastically boil over. Hence, it is preferable that the process oil be heated in the range from 140 to 180° C.

After the process oil is loaded and stirred, a plasticizer and a thermoplastic resin are loaded into the mixer, and then stirred. As such, the plasticizer functions to improve the low-temperature properties of a binder and confer ductility to each resin, and also, causes a pigment to be efficiently dispersed in the binder. The plasticizer is selected from among dioctyl phthalate (DOP), diisononyl phthalate (DINP), dibutyl phthalate (DBP), and mixtures thereof, but is not limited thereto.

The thermoplastic resin acts to control high-temperature fluidity, enhance stickiness, adhesive strength, hardness, and control toughness and tenacity showing a cohesive strength with aggregate. The thermoplastic resin is selected from among a petroleum resin, polystyrene (PS), polyethylene (PE), polypropylene (PP), atatic-polypropylene, atatic-polypropylene copolymer, amorphous olefin polymer, ethylene vinyl acetate (EVA), ethylene ethyl acrylate (EEA) copolymer, and mixtures thereof, but is not limited thereto.

In addition, when the plasticizer and thermoplastic resin are loaded and stirred, the temperature is maintained at 160-200° C. to achieve a homogeneous phase. If the temperature required for addition and stirring is less than 160° C., it is difficult to maintain a homogeneous phase. On the other hand, if the temperature exceeds 200° C., the thermoplastic resin may deteriorate. Thus, the temperature should be maintained in the range from 160 to 200° C.

After the plasticizer and thermoplastic resin are loaded and then stirred, a thermoplastic elastomer is loaded into the mixer and then stirred. As such, the thermoplastic elastomer functions to increase both high-temperature and low-temperature properties of a binder, and in particular, reinforce low-temperature elasticity and increase high-temperature viscosity. The thermoplastic elastomer is selected from among a styrene butadiene block copolymer (SBS), a styrene isoprene block copolymer (SIS), and mixtures thereof, but is not limited thereto.

In addition, the thermoplastic elastomer is loaded and stirred at 160-200° C. to achieve a homogeneous phase, as in the plasticizer and thermoplastic resin. When the temperature required for loading and stirring is lower than 160° C., a homogeneous phase may not be maintained. However, if the above temperature exceeds 200° C., the thermoplastic elastomer may break. Hence, the temperature should be maintained in the range from 160 to 200° C.

After thermoplastic elastomer is loaded and stirred, a dispersion pigment is loaded into the mixer and then stirred. In the dispersion pigment, since powdered pigment is impossible to disperse in the binder, it is sufficiently pre-dispersed in a carrier or a dispersion medium, and thus, the properties of the binder are not worsened. In addition, even if the pigment is used in a small amount, clear color may be desirably shown. The dispersion pigment is processed by uniformly dispersing powdered pigment in the process oil, the thermoplastic resin, and the plasticizer, serving as a carrier or dispersion medium, so that the pigment may be uniformly dispersed in the binder.

The binder thus prepared is mixed with general asphalt concrete to construct variously paved roads, therefore exhibiting excellent weather resistance and durability and maintaining clear color.

When preparing the coloring binder, each material constituting the binder is used in a mixing ratio noted below, based on 100 wt % of the coloring binder.

To prepare the binder, 2-6 wt % rubber latex, 22-50 wt % process oil, 32-60 wt % thermoplastic resin, 5-15 wt % thermoplastic elastomer, 1-4 wt % plasticizer, and 10-20 wt % dispersion pigment are used.

If the rubber latex is added in an amount less than 2 wt %, the properties of the rubber are difficult to exhibit. On the other hand, if the above amount exceeds 6 wt %, the viscosity of the product is too high, and thus, problems may occur during use. In addition, if the process oil is added in an amount less than 22 wt %, dispersion and mixing with other materials are difficult. Conversely, if the above amount exceeds 50 wt %, the product has low hardness. In addition, if the thermoplastic resin is added in an amount less than 32 wt %, the product does not exhibit hardness. However, if the above amount exceeds 60 wt %, elasticity of the product is drastically reduced, thus weakening impact resistance. In addition, if the thermoplastic elastomer is added in an amount less than 5 wt %, elasticity is insufficiently exhibited. On the other hand, if the above amount exceeds 15 wt %, the viscosity of the product is drastically increased, and thus, problems may be caused during use. In addition, if the plasticizer is added in an amount less than 1 wt %, sufficient plastic effects cannot be expected. On the other hand, if the above amount exceeds 4 wt %, hardness of the product is drastically decreased. In addition, if the dispersion pigment is added in an amount less than 10 wt %, masking effects and coloring efficiency are decreased. Meanwhile, if the above amount exceeds 20 wt %, the price of the product is excessively increased.

Therefore, the coloring binder for road pavement, prepared according to the above method and mixing ratio, comprises 2-6 wt % rubber latex, 22-50 wt % process oil, 32-60 wt % thermoplastic resin, 5-15 wt % thermoplastic elastomer, 1-4 wt % plasticizer, and 10-20 wt % dispersion pigment.

Since functions and mixing ratios of each constituent are mentioned above, specific descriptions thereof are omitted.

In this way, the coloring binder for road pavement of the present invention has properties, such as softening point and penetration, superior to conventional asphalt for road pavement. The coloring binder was prepared in accordance with various mixing ratios, properties of which were measured several times. The results are shown in Table 1 below.

TABLE 1
Comparison of Properties of Inventive Coloring Binder and Conventional
Asphalt for Pavement of Road

| | | Conventional Asphalt | | Inventive Binder | |
|---|---|---|---|---|---|
| Properties | | AP-3 | AP-5 | A | C |
| Color (Visual Inspection) | | Black | Black | Pigment | Pigment |
| | | | | Coloring | Coloring |
| Softening Point (° C.) | | 40 ± 3 | 40-60 | 50-90 | 50-90 |
| Penetration (25° C., 1/10 mm) | | 85-100 | 60-70 | 20-50 | 30-60 |
| Elongation (25° C., 7 cm) | | 100 or more | 40 or more | 100 or more | 100 or more |
| Elongation (7° C., 7 cm) | | — | — | 30 or more | 50 or more |
| Flash Point (° C.) | | 200 or more | 200 or more | 210 or more | 210 or more |
| After | Vapor Decrease (%) | 1 or less | 1 or less | 2 or more | 2 or more |
| Heating | Penetration | 60 or more | 60 or more | 60 or more | 60 or more |
| Thin Film | (25° C., 1/10 mm) | | | | |
| (165° C., 5 hr) | Elongation | 50 or more | 50 or more | 50 or more | 50 or more |
| | (25° C., 7 cm) | | | | |

| | | | | |
|---|---|---|---|---|
| Toughness (kgf · cm) | — | — | 200 or more | 140 or more |
| Tenacity (kgf · cm) | — | — | 150 or more | 100 or more |
| PG grade(° C.) | 58-22 | 64-22 | 82-22 | 76-22 |

As is apparent from Table 1, the coloring binder of the present invention has properties superior to conventional asphalt for road pavement. Hence, the coloring binder of the present invention is mixed with general asphalt concrete, permeable and porous asphalt concrete, colored asphalt concrete, etc., whereby a road paving material having clear color and high durability may be provided.

A better understanding of the present invention may be obtained through the following examples which are set forth to illustrate, but are not to be construed as the limit of the present invention.

### EXAMPLES 1-2

Each coloring binder was prepared depending on a mixing ratio shown in Table 2 below, properties of which were measured. The results are shown in Table 3, below.

TABLE 2
Mixing Ratios used in Examples 1 and 2 (wt %)

| | | Paraffin | | | | | |
|---|---|---|---|---|---|---|---|
| Ex. | Naphthene | Process | | | Petroleum | SBR | Pigment |
| No. | Process Oil | Oil | DOP | SBS | Resin | Latex | (Red) |
| 1 | 20 | 18 | 2 | 7 | 40 | 3 | 10 |
| 2 | 38 | — | 2 | 7 | 40 | 3 | 10 |

TABLE 3
Properties measured in Examples 1 and 2

| Properties | | Ex. 1 | Ex. 2 |
|---|---|---|---|
| Color (visual inspection) | | Red | Red |
| Softening Point (° C.) | | 60 | 58 |
| Penetration (25° C., 1/10 mm) | | 55 | 60 |
| Elongation (7° C., 7 cm) | | 50 or more | 100 r more |
| Flash Point (° C.) | | 220 or more | 210 or more |
| After Heating Thin | Vapor Decrease (%) | 0.5 | 0.6 |
| Film | Penetration | 85 | 90 |
| (165° C., 5 hr) | (25° C., 1/10 mm) | | |
| | Elongation | 100 or more | 100 or more |
| | (7° C., 7 cm) | | |

| | | |
|---|---|---|
| Toughness (kgf · cm) | 350 | 340 |
| Tenacity (kgf · cm) | 240 | 230 |

### EXAMPLE 3

A permeable and porous asphalt concrete mixture for use in pavement was prepared using the coloring binder of the present invention, properties of which were measured. As such, a test piece was manufactured under conditions of a mixing temperature of 170-180° C., and a compacting temperature of 160-170° C., and compacting each of the upper surface and the lower surface of the test piece 75 times by freely dropping a 4536 g hammer from a height of 457.2 mm, according to a standard method of KS F 2337.

In Table 4 below, materials used in the preparation of the permeable and porous mixture and amounts thereof are shown. Also, properties of the prepared permeable and porous mixture are given in Table 5, below.

TABLE 4
Materials and Amounts used in Example 3

| | Aggregate | | | |
|---|---|---|---|---|
| | Coarse Aggregate | | | Coloring |
| | (19 mm) | Stone Dust (S.K) | Sand | Binder |
| Amount (wt %) | 73.9 | 13.5 | 7.6 | 5.0 |

TABLE 5
Properties measured in Example 3

| | Marshall | Flow Rate | Porosity | Density |
|---|---|---|---|---|
| Properties | Stability | (1/100 cm) | (%) | (g/cm³) |
| Standard (KS M | 350 | 20-40 | — | — |
| 2349) | | | | |
| Result | 710 | 35 | 24 | 2.195 |

### COMPARATIVE EXAMPLE 1

A permeable and porous asphalt concrete mixture for use in pavement was prepared using a general paving asphalt binder, properties of which were measured. The results are shown in Tables 6 and 7 below.

TABLE 6
Materials and Amounts used in Comparative Example 1

| | Aggregate | | | | |
|---|---|---|---|---|---|
| | Coarse Aggregate | | | | |
| | (19 mm) | Stone Dust (S.K) | Sand | AP-5 | Filler |
| Amount | 60.2 | 21.3 | 11.0 | 4.5 | 3.0 |
| (wt %) | | | | | |

TABLE 7
Properties measured in Comparative Example 1

| | Marshall | Flow Rate | | Density |
|---|---|---|---|---|
| Properties | Stability | (1/100 cm) | Porosity (%) | (g/cm³) |
| Standard (KS M 2349) | 350 | 20-40 | — | — |
| Result | 430 | 30 | 12.5 | 2.273 |

As is apparent from examples and comparative examples, the asphalt concrete mixture formed from the coloring binder of the present invention had Marshall stability two times higher than the asphalt concrete mixture formed from the general asphalt binder. Thus, the coloring binder of the present invention can be confirmed to exhibit excellent properties, compared to conventional binders.

As described above, the present invention provides a method of preparing a coloring binder for road pavement and a coloring binder prepared thereby. According to the present invention, when the coloring binder which is modified by a specific polymer and contains a pigment dispersed therein is mixed with general asphalt concrete, it may easily exhibit clear color, high durability and weather resistance, and thus, may be variously used in color pavement of roads including seldom- and frequently-traveled vehicle roads. As well, the binder of the present invention is environmentally friendly, and may be easily maintained.

In addition, color pavement using the coloring binder of the present invention is manufactured in the same manner as general asphalt concrete, whereby problems, such as a long manufacturing period, complicated processes and high personnel expense, due to the color pavement in the road, may be solved. Thus, color pavement is easily completed, and may be applied to bicycle paths, park roads, paved roads, and athletic facilities including playgrounds. Hence, the coloring binder of the present invention will contribute to the popularization of color pavement.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of preparing a coloring binder for road pavement, comprising the steps of:
loading rubber latex into a mixer;
loading process oil heated to 140-180° C. into the mixer having the rubber latex loaded therein, and then stirring the loaded process oil;
loading a plasticizer and a thermoplastic resin into the mixer having the process oil loaded and stirred therein, and then stirring the loaded plasticizer and thermoplastic resin;
loading a thermoplastic elastomer into the mixer having the plasticizer and thermoplastic resin loaded and stirred therein, and then stirring the loaded thermoplastic elastomer; and
loading a dispersion pigment into the mixer having the thermoplastic elastomer loaded and stirred therein, and then stirring the loaded dispersion pigment.

2. The method as set forth in claim 1, wherein the loading and stirring of the thermoplastic resin are performed while maintaining a temperature of 160-200° C. to achieve a homogeneous phase.

3. The method as set forth in claim 1, wherein the loading and stirring of the thermoplastic elastomer are performed while maintaining a temperature of 160-200° C. to achieve a homogeneous phase.

4. The method as set forth in claim 1, wherein the rubber latex is added in an amount of 2-6 wt %, the process oil is added in an amount of 22-50 wt %, the thermoplastic resin is added in an amount of 32-60 wt %, the thermoplastic elastomer is added in an amount of 5-15 wt %, the plasticizer is added in an amount of 1-4 wt %, and the dispersion pigment is added in amount of 10-20 wt %, based on 100 wt % of the coloring binder.

5. The method as set forth in claim 2, wherein the rubber latex is added in an amount of 2-6 wt %, the process oil is added in an amount of 22-50 wt %, the thermoplastic resin is added in an amount of 32-60 wt %, the thermoplastic elastomer is added in an amount of 5-15 wt %, the plasticizer is added in an amount of 1-4 wt %, and the dispersion pigment is added in amount of 10-20 wt %, based on 100 wt % of the coloring binder.

6. The method as set forth in claim 3, wherein the rubber latex is added in an amount of 2-6 wt %, the process oil is added in an amount of 22-50 wt %, the thermoplastic resin is added in an amount of 32-60 wt %, the thermoplastic elastomer is added in an amount of 5-15 wt %, the plasticizer is added in an amount of 1-4 wt %, and the dispersion pigment is added in amount of 10-20 wt %, based on 100 wt % of the coloring binder.

7. The method as set forth in claim 1, wherein the rubber latex is selected from the group consisting of solid and latex type styrene butadiene rubber, natural rubber latex, and mixtures thereof.

8. The method as set forth in claim 1, wherein the process oil is selected from the consisting of aromatic, paraffin, naphthenee process oils, and mixtures thereof.

9. The method as set forth in claim 1, wherein the plasticizer is selected from the group consisting of dioctyl phthalate, diisononyl phthalate, dibutyl phthalate, and mixtures thereof.

10. The method as set forth in claim 1, wherein the themoplastic resin is selected from the group consisting of petroleum resin, polystyrene, polyethylene, polypropylene, atatic-polypropylene, an atatic-polypropylene copolymer, an amorphous olefin polymer, ethylenevinylacetate, an ethyleneethylacrylate copolymer, and mixtures thereof.

11. The method as set forth in claim 1, wherein the thermoplastic elastomer is selected from the group consisting of styrene butadiene block copolymer, a styrene isoprene block copolymer, and mixtures thereof.

12. The method as set forth in claim 1, wherein the dispersion pigment is processed by uniformly dispersing powdered pigment in the process oil, the thermoplastic resin, or the plasticizer serving as a dispersion medium.

13. A coloring binder for road pavement, comprising 2-6 wt % rubber latex, 22-50 wt % process oil, 32-60 wt % thermoplastic resin, 5-15 wt % thermoplastic elastomer, 1-4 wt % plasticizer, and 10-20 wt % dispersion pigment.

14. A method of preparing a coloring binder for road pavement, comprising the steps of:
loading rubber latex into a mixer;
loading process oil heated to 140-180° C. into the mixer having the rubber latex loaded therein, and then stirring the loaded process oil;
loading a plasticizer and a thermoplastic resin into the mixer having the process oil loaded and stirred therein, and then stirring the loaded plasticizer and thermoplastic resin;
loading a thermoplastic elastomer into the mixer having the plasticizer and thermoplastic resin loaded and stirred therein, and then stirring the loaded thermoplastic elastomer; and
loading a dispersion pigment into the mixer having the thermoplastic elastomer loaded and stirred therein, and then stirring the loaded dispersion pigment,
in which the dispersion pigment is processed by uniformly dispersing a powdered pigment in the process oil, the thermoplastic resin, or the plasticizer serving as a dispersion medium, and
the rubber latex is added in an amount of 2-6 wt %, the process oil is added in an amount of 22-50 wt %, the thermoplastic resin is added in an amount of 32-60 wt %, the thermoplastic elastomer is added in an amount of 5-15 wt %, the plasticizer is added in an amount of 1-4 wt %, and the dispersion pigment is added in amount of 10-20 wt %, based on 100 wt % of the coloring binder.

15. The method as set forth in claim 14, wherein the loading and stirring of the thermoplastic resin are performed while maintaining a temperature of 160-200° C. to achieve a homogeneous phase.

16. The method as set forth in claim 14, wherein the loading and stirring of the thermoplastic elastomer are performed while maintaining a temperature of 160-200° C. to achieve a homogeneous phase.

17. The method as set forth in claim 14, wherein the rubber latex is selected from the group consisting of solid and latex type styrene butadiene rubber, natural rubber latex, and mixtures thereof.

18. The method as set forth in claim 14, wherein the process oil is selected from the group consisting of aromatic, paraffin, naphthenee process oils, and mixtures thereof.

19. The method as set forth in claim 14, wherein the plasticizer is selected from the group consisting of dioctyl phthalate, diisononyl phthalate, dibutyl phthalate, and mixtures thereof.

20. The method as set forth in claim 14, wherein the themoplastic resin is selected from the group consisting of petroleum resin, polystyrene, polyethylene, polypropylene, atatic-polypropylene, an atatic-polypropylene copolymer, an amorphous olefin polymer, ethylenevinylacetate, an ethyleneethylacrylate copolymer, and mixtures thereof.

21. The method as set forth in claim 14, wherein the thermoplastic elastomer is selected from the group consisting of styrene butadiene block copolymer, a styrene isoprene block copolymer, and mixtures thereof.

22. A coloring binder for road pavement, comprising 2-6 wt % rubber latex, 22-50 wt % process oil, 32-60 wt % thermoplastic resin, 5-15 wt % thermoplastic elastomer, 1-4 wt % plasticizer, and 10-20 wt % dispersion pigment, in which the dispersion pigment is processed by uniformly dispersing powdered pigment in the process oil, the thermoplastic resin, or the plasticizer serving as a dispersion medium.
